(19) United States
(12) Patent Application Publication
(10) Pub. No.: US 2004/0035852 A1
(43) Pub. Date: Feb. 26, 2004

(54) Steel plate splicing facility utilizing shear joining

(76) Inventors: Tsutomu Kawamizu, Hiroshima-shi (JP); Ritsuo Hashimoto, Hiroshima-shi (JP); Etsurou Hirai, Hiroshima-shi (JP); Shiochi Hashimoto, Hiroshima-shi (JP); Kanji Hayashi, Hiroshima-shi (JP)

Correspondence Address: BIRCH STEWART KOLASCH & BIRCH, PO BOX 747, FALLS CHURCH, VA, 22040-0747, US

(21) Appl. No.: 10/463,785

(22) Filed: Jun. 18, 2003

(30) Foreign Application Priority Data
Jul. 11, 2002 (JP) 2002-202321

(51) Int. Cl. H05B 3/02

(52) U.S. Cl. 219/546

(57) ABSTRACT

A steel plate splicing facility includes a steel plate heating apparatus for heating a preceding material and a following material, and a shear-joining apparatus for joining the preceding material and the following material. The preceding material is a steel plate currently undergoing pickling, or pickling and cold rolling, and the following material is the next steel plate to undergo pickling, or pickling and cold rolling. In the shear-joining apparatus, the preceding material and the following material are clamped in an overlapping condition by means of a die and a clamp and are sheared by means of a punch in such a manner as to bring respective newly-formed surfaces in contact with each other for joining.

The entire disclosure of Japanese Patent Application No. 2002-202321 filed on Jul. 11, 2002 including specification, claims, drawings and summary is incorporated herein by reference in its entirety.

### BACKGROUND OF THE INVENTION

1. Field of the Invention

The present invention relates to a steel plate splicing facility which utilizes shear joining. More particularly, the invention relates to a steel plate splicing facility adapted to join steel plates which have undergone hot rolling and are to undergo pickling, or pickling and cold rolling.

2. Description of the Related Art

Conventionally, as shown in FIGS. 16A and 16B, a steel plate (hereinafter may be referred to as a preceding material) 1 which is currently undergoing pickling, or pickling and cold rolling, and a steel plate (hereinafter may be referred to as a following material) 2 which is to next undergo pickling, or pickling and cold rolling are joined by, for example, flash butt processing or laser processing.

Specifically, the preceding material 1 passes through shears 10, a clamp apparatus 11, a joining apparatus 12 such as a laser welding machine or a flash butt joining machine, and a clamp apparatus 11; undergoes notch treatment and joint treatment; and is then sent to looper equipment and pickling equipment.

The preceding material 1 and the following material 2 are clamped by the corresponding clamp apparatus 11, and the following material 2 is laser-welded or flash butt-welded to the preceding material 1 by the joining apparatus 12.

Incidentally, a steel plate must be continuously conveyed at a predetermined speed, for the following reason. If travel of the steel plate stops while the steel plate is in a pickling bath, surface properties of the steel plate will be impaired by excessive pickling.

Since the conventional joining method involves long joining time, a large looper equipment (equipment for buffering a steel plate) must be installed, thereby raising a problem in that the size of the overall equipment becomes large.

### SUMMARY OF THE INVENTION

An object of the present invention is to solve the above-mentioned problem in the conventional steel plate splicing facility and to provide a steel plate splicing facility allowing simplification of looper equipment.

To achieve the above object, the present invention provides a steel plate splicing facility comprising a steel plate heating apparatus for heating a preceding material and a following material to a predetermined temperature, the preceding material being a steel plate currently undergoing pickling, or pickling and cold rolling, and the following material being a next steel plate to undergo pickling, or pickling and cold rolling; and a shear-joining apparatus for clamping a tail end portion of the preceding material and a leading end portion of the following material in an overlapping condition by means of a die and a clamp and for shearing the tail end portion of the preceding material and the leading end portion of the following material by means of a punch in such a manner that surfaces of the tail end portion and the leading end portion that are newly formed as a result of the shearing are brought in contact with each other in order to join the leading end portion of the following material to the tail end portion of the preceding material. Thus, in contrast to the conventional joining method such as flash butt processing and laser processing, surfaces to be joined can be of low accuracy, and joining time is very short, whereby the overall time of the joining process can be considerably reduced, and looper equipment can be simplified considerably.

The steel plate heating apparatus may comprise a device for heating the following material through induction heating, and a device for nipping the preceding material and the following material by means of a heating clamp in order to heat the preceding material and the following material through contact heat conduction from the heating clamp, the heating clamp being preheated through induction heating. Thus, the preceding material and the following material can be reliably heated.

Alternatively, the steel plate heating apparatus may comprise a device for heating the following material through induction heating, and a device for heating the preceding material and the following material in an overlapping condition through induction heating. In this case as well, the preceding material and the following material can be reliably heated.

Alternatively, the steel plate heating apparatus may comprise a device for heating the preceding material and the following material in an overlapping condition through induction heating. In this case as well, the preceding material and the following material can be reliably heated.

Preferably, the shear-joining apparatus performs joining of the steel plates at a steel plate temperature equal to or higher than 350° C. and at a percentage clearance c/t equal to or lower than 5%. The percentage clearance c/t is a clearance between the punch and the die represented by

c/t=D/(t₁+t₂)×100

where D represents a distance between the punch and the die, and t₁ and t₂ represent respective thicknesses of the preceding material and the following material as measured at a location where the preceding material and the following material overlap each other. Thus, joining is favorably performed such that the strength of joint is higher than that of base material.

The shear-joining apparatus may perform joining such that a joint surface extends linearly or nonlinearly. In either case, newly-formed surfaces are reliably joined together.

The shear-joining apparatus may perform joining such that the steel plate on a side toward the punch is pressed by means of the punch so as to be joined to the other steel plate at an arbitrary number of positions along the width direction of the steel plate. Further, the shear-joining apparatus may perform joining such that the punch forms a cylindrical joint surface.

### BRIEF DESCRIPTION OF THE DRAWINGS

FIGS. 1A and 1B are overall views of a steel plate splicing facility according to a first embodiment of the present invention, wherein FIG. 1A shows a state during joining, and FIG. 1B shows a state after joining;

FIG. 2 is an explanatory view showing a shear-joining apparatus (as viewed before joining) according to the first embodiment;

FIG. 3 is an explanatory view showing the shear-joining apparatus (as viewed after joining) according to the first embodiment;

FIG. 4 is an explanatory view showing a joint surface according to the first embodiment;

FIGS. 5A and 5B are overall views of a steel plate splicing facility according to a second embodiment of the present invention, wherein FIG. 5A shows a state during joining, and FIG. 5B shows a state after joining;

FIG. 6 is an explanatory view showing a shear-joining apparatus (as viewed before joining) according to the second embodiment;

FIG. 7 is an explanatory view showing the shear-joining apparatus (as viewed after joining) according to the second embodiment;

FIG. 8 is an explanatory view showing a joint surface according to the second embodiment;

FIGS. 9A and 9B are overall views of a steel plate splicing facility according to a third embodiment of the present invention, wherein FIG. 9A shows a state during joining, and FIG. 9B shows a state after joining;

FIG. 10 is an explanatory view showing a shear-joining apparatus (as viewed after joining) according to the third embodiment;

FIGS. 11A and 11B are explanatory views showing a joint surface according to the third embodiment;

FIGS. 12A and 12B are explanatory view showing the shearing operation according to the first embodiment;

FIG. 13 is a graph showing the relationship between the strength of a joint and joining temperature (steel plate temperature);

FIG. 14 is a graph showing the relationship between the strength of a joint and percentage clearance;

FIGS. 15A and 15B are views schematically showing a conventional splicing method and a splicing method according to the present invention, respectively; and

FIGS. 16A and 16B are overall views of a conventional steel plate splicing facility, wherein FIG. 16A shows a state during joining, and FIG. 16B shows a state after joining.

### DESCRIPTION OF THE PREFERRED EMBODIMENTS

Embodiments of the present invention will next be described in detail with reference to the drawings.

[First Embodiment]

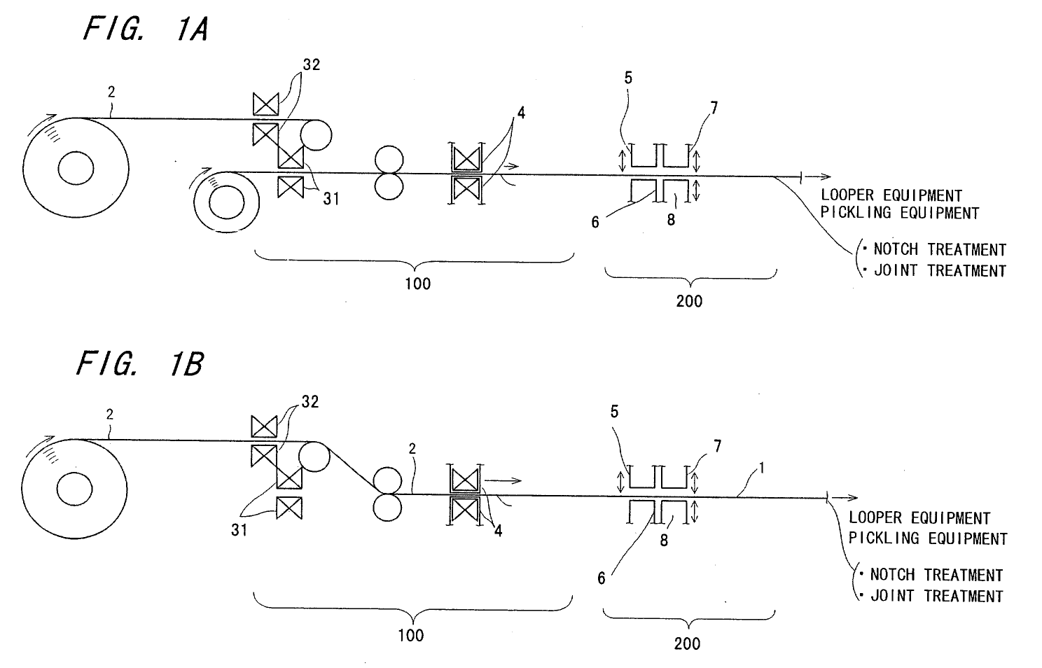

FIGS. 1A, 1B, 2, 3, and 4 show a steel plate splicing facility according to a first embodiment of the present invention.

As shown in FIGS. 1A and 1B, the steel plate splicing facility according to the present embodiment includes a steel plate heating apparatus 100 and a shear-joining apparatus 200. A steel plate 1 having passed through the shear-joining apparatus 200 undergoes notch treatment and joint treatment, and is then sent to looper equipment and pickling equipment as in the conventional facility.

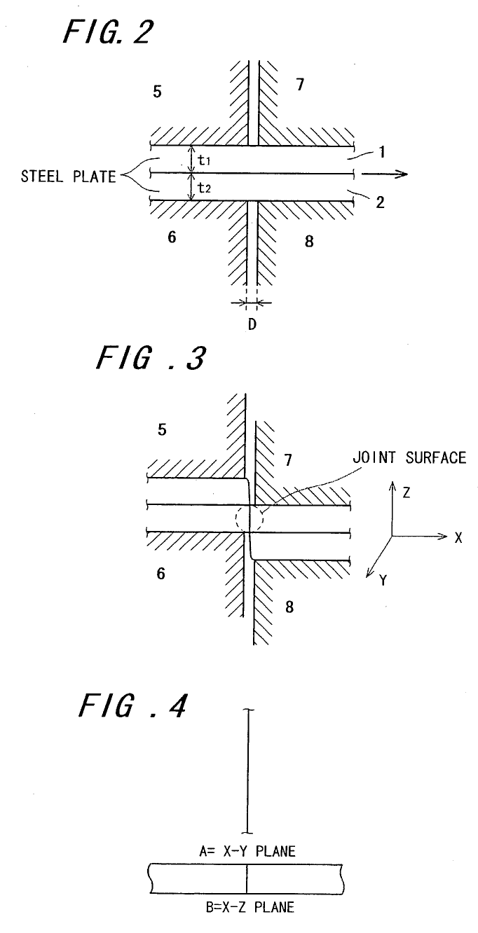

In FIGS. 2 and 3, the preceding material overlies the following material. However, the positional relationship between the preceding and following materials is not limited thereto; i.e., the following material may overlie the preceding material. FIGS. 2 to 4 show the conditions of the preceding and following materials in the process of and after joining as viewed on a cross section taken along the thickness of a steel plate (as viewed on the X-Z plane).

In FIGS. 1A and 1B, the clamp, punch, and punch-backing member are vertically movable, and the die is stationary. However, the die is not necessarily stationary, but may be vertically movable under certain conditions.

The steel plate heating apparatus 100 includes a following-material heating apparatus 31, a following-material heating apparatus 32, and a preceding-material/following-material heating apparatus 4, and is adapted to heat steel plates 1 and 2 to a predetermined temperature.

Herein, the expression “to heat to a predetermined temperature” means, for example, that a steel plate of the atmospheric temperature (about 30° C.) can be heated to a temperature of 1,000° C. or higher.

The following-material heating apparatus 31 is adapted to heat, through induction heating, a leading end portion of a steel plate (hereinafter referred to as a preceding material) 1 which is currently undergoing pickling, or pickling and cold rolling. The following-material heating apparatus 32 is adapted to heat, through induction heating, a leading end portion of a next steel plate (hereinafter referred to as a following material) 2 which is to undergo pickling, or pickling and cold rolling.

A method for heating the preceding material 1 is not limited to induction heating as illustrated in FIGS. 1A and 1B. The preceding material 1 may be heated through direct or radiant heating by use of a burner or through contact heat conduction from a heating body. This also applies to heating of the following material 2.

After the following material 2 is heated, a tail end portion of the preceding material 1 and a leading end portion of the following material 2 are superposed on each other. The heating apparatus 4 grips the preceding material 1 and the following material 2 at the overlap portion and heats the overlap portion through contact heat conduction. The heating apparatus 4 is a heating clamp (a high-temperature member), which is preheated to a predetermined temperature through induction heating.

The heating apparatus 4 does not necessarily need to perform contact heat conduction, but may perform induction heating or heating with, for example, a burner.

The following material 2 may be heated in the present process instead of being heated in a separate process.

The shear-joining apparatus 200 includes a stationary die 6, a clamp 5, which is vertically movable in relation to the die 6, a vertically movable punch 7, and a punch-backing member 8.

As shown in FIG. 2, an overlap portion of the preceding material 1 and the following material 2 is gripped between the die 6 and the clamp 5 through movement of the clamp 5 toward the die 6, and the punch 7 is pressed down toward the punch-backing member 8 for punching. As a result, at the overlap portion of the two steel plates, the punch 7 causes a fracture surface of one steel plate to be brought in contact with a fracture surface of the other steel plate.

In FIG. 2, the preceding material overlies the following material. However, the positional relationship between the preceding and following materials is not limited thereto; i.e., the following material may overlie the preceding material.

As shown in FIG. 3, after being heated, the tail end portion of the preceding material 1 and the leading end portion of the following material 2 are sheared, and the respective newly-formed surfaces form a joint surface (marked with the broken line in FIG. 3). The newly-formed surfaces come into contact with each other at high temperature without presence of impurities such as an oxide film therebetween. Such impurities are usually present on the surface of a steel plate at high temperature.

As shown in FIG. 2, according to the present embodiment, the newly-formed surfaces come into contact with each other at high temperature as a result of subjection to pressing forces induced in the X direction or radially by the clamp 5, the punch 7, the punch-backing member 8, and the die 6, to thereby be joined together through diffusion of metal atoms.

The punch 7 and the die 6 used in the present embodiment are formed such that, as shown in FIG. 4, the joint surface extends linearly as viewed on the X-Y plane.

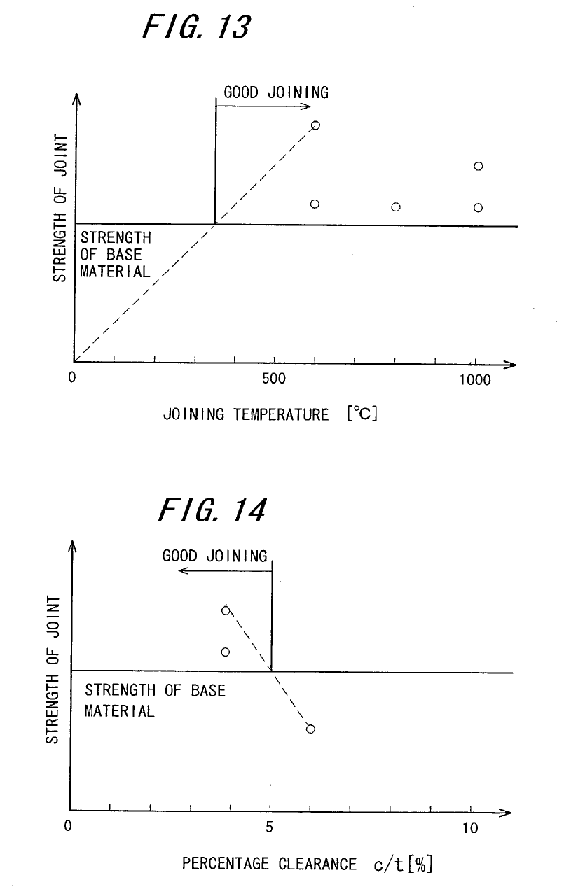

The steel plate splicing facility according to the present embodiment was tested by use of steel plates. The results of the test are shown in FIG. 13. As shown in FIG. 13, at a steel plate temperature equal to or higher than 350° C., a joint is formed under good conditions such that the strength of the joint is higher than that of base material. Also, as shown in FIG. 14, when the percentage clearance c/t defined below by Eq. (1) is equal to or lower than 5%, a joint is formed under good conditions such that the strength of the joint is higher than that of base material.

The expression “good joining” appearing in FIGS. 13 and 14 means that the strength of a joint is equal to or higher than that of base material and does not allow occurrence of fracture of a steel plate when the steel plate undergoes pickling, or pickling and cold rolling. The strength of base material varies depending on base material and is peculiar to base material. However, since the test has revealed that, at a steel plate temperature equal to or higher than 350° C. and at a percentage clearance c/t equal to or lower than 5%, the strength of a joint becomes equal to or higher than that of base material, the present invention specifies the steel plate temperature and the percentage clearance c/t as 350° C. or higher and 5% or lower, respectively. Notably, the strength of base material is the tensile strength of base material. FIG. 13 shows the results of the test in which the strength of a joint was tested while the temperature of a steel plate at the time of joining was varied as a parameter. FIG. 14 shows the results of the test in which the strength of a joint was tested while the percentage clearance c/t at the time of joining was varied as a parameter.

c/t=D/(t₁+t₂)×100 (1)

where D is the clearance in the X direction between the punch 7 and the die 6, and t₁ and t₂ are the thickness of the preceding material 1 and that of the following material 2, respectively, as measured at their overlap portion.

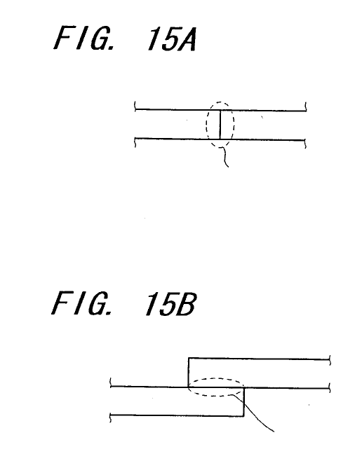

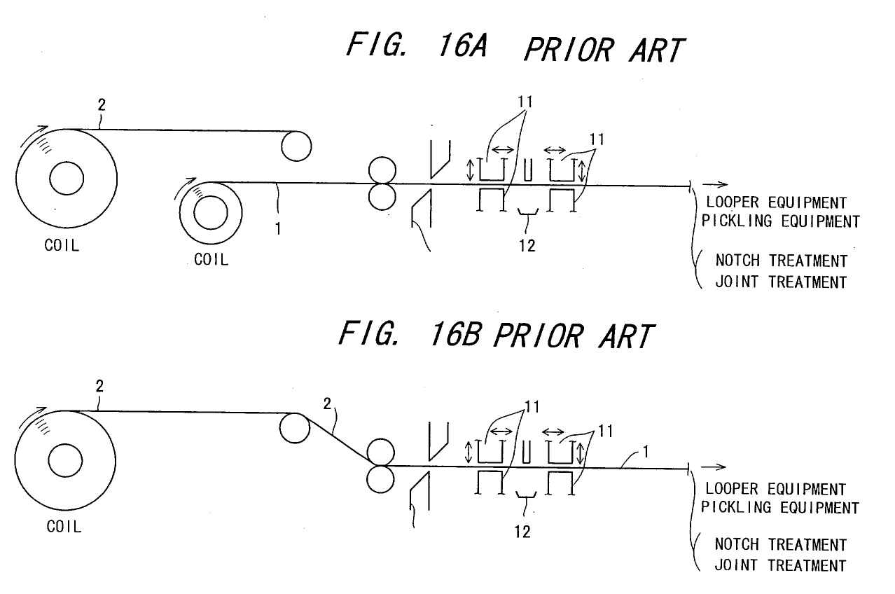

As shown in FIGS. 15A and 15B, in contrast to the conventional joining method such as flash butt processing and laser processing, the method of joining steel plates according to the present embodiment is advantageous in that surfaces to be joined can be of low accuracy, and joining time is very short, specifically one second or less. Thus, the overall time of the joining process can be considerably reduced, and looper equipment can be simplified considerably.

Specifically, according to the conventional method, as marked with the broken line in FIG. 15A, a leading end surface of the following material and a tail end surface of the preceding material butt to each other; thus, preparation for joining consumes about 25 seconds. By contrast, according to the present embodiment, as marked with the broken line in FIG. 15B, a leading end portion of the following material and a tail end portion of the preceding material are superposed on each other; thus, preparation time for joining is considerably reduced from 25 seconds.

Furthermore, since the conventional method employs a flash butt processing, in which voltage is applied to the entire end surfaces, or a laser processing, in which a laser head is moved, joining time is as long as about 10 seconds. By contrast, according to the present embodiment, joining time is time that the punch 7 consumes for punching (one second or less), and is thus short.

[Second Embodiment]

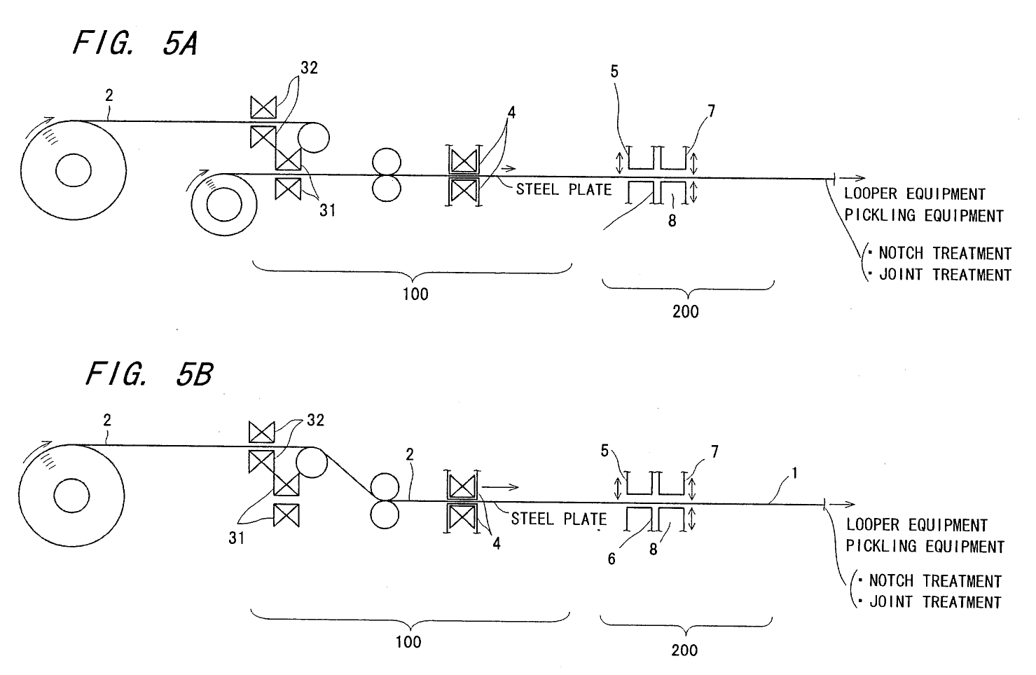

FIGS. 5A, 5B, 6, 7, and 8 show a steel plate splicing facility according to a second embodiment of the present invention.

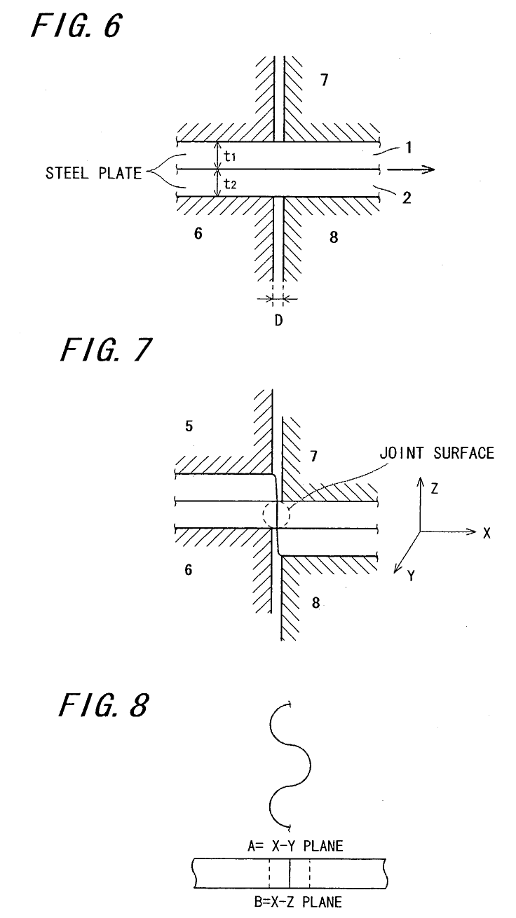

In FIGS. 6 and 7, the preceding material overlies the following material. However, the positional relationship between the preceding and following materials is not limited thereto; i.e., the following material may overlie the preceding material. FIGS. 6 to 8 show the condition of the preceding and following materials in the process of and after joining as viewed on a cross section taken along the thickness of a steel plate (as viewed on the X-Z plane). Notably, in order to explain the condition of a joint along the width direction of a steel plate, FIG. 8 includes a view showing the X-Y plane as viewed from above the steel plate.

In FIGS. 5A and 5B, the clamp, punch, and punch-backing member are vertically movable, and the die is stationary. However, the die is not necessarily stationary, but may be vertically movable under certain conditions.

As shown in FIGS. 5A and 5B, the steel plate splicing facility according to the present embodiment assumes a basic configuration similar to that of the first embodiment and differs from the first embodiment in that, as shown in FIG. 8, the joint surface extends along a curved or rectangularly bent line as viewed on the X-Y plane.

The punch 7 and the die 6 used in the present embodiment are formed such that the joint surface assumes the above-mentioned profile. The other structural feature of the present embodiment is similar to that of the first embodiment.

Thus, also in the present embodiment, as shown in FIG. 6, an overlap portion of the preceding material 1 and the following material 2 is gripped between the die 6 and the clamp 5 through movement of the clamp 5 toward the die 6, and the punch 7 is pressed down toward the punch-backing member 8 for punching. As a result, at the overlap portion of the two steel plates, the punch 7 causes a fracture surface of one steel plate to be brought in contact with a fracture surface of the other steel plate.

As shown in FIG. 7, after being heated, a tail end portion of the preceding material 1 and a leading end portion of the following material 2 are sheared, and the respective newly-formed surfaces form a joint surface (marked with the broken line in FIG. 7). The newly-formed surfaces come into contact with each other at high temperature without presence of impurities such as an oxide film therebetween. Such impurities are usually present on the surface of a steel plate at high temperature.

As in the case of the first embodiment, the present embodiment is also characterized in that, at a steel plate temperature equal to or higher than 350° C., a joint is formed under good conditions such that the strength of the joint is higher than that of base material and that, when the percentage clearance c/t defined above by Eq. (1) is equal to or lower than 5%, a joint is formed under good conditions such that the strength of the joint is higher than that of base material.

[Third Embodiment]

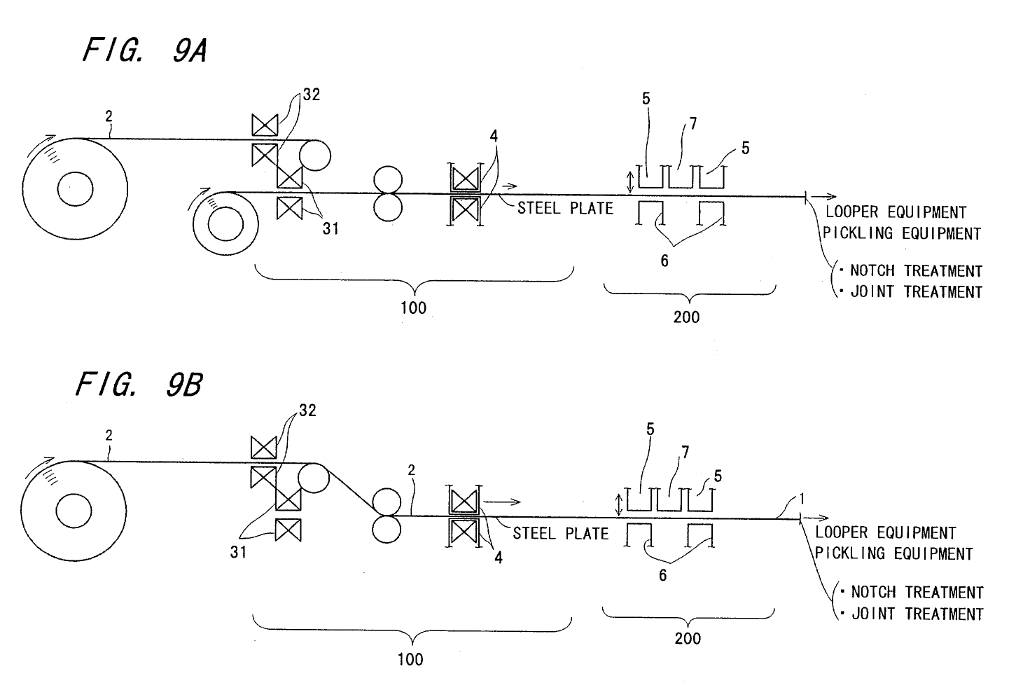

FIGS. 9A, 9B, 10, 11A, and 11B show a steel plate splicing facility according to a third embodiment of the present invention.

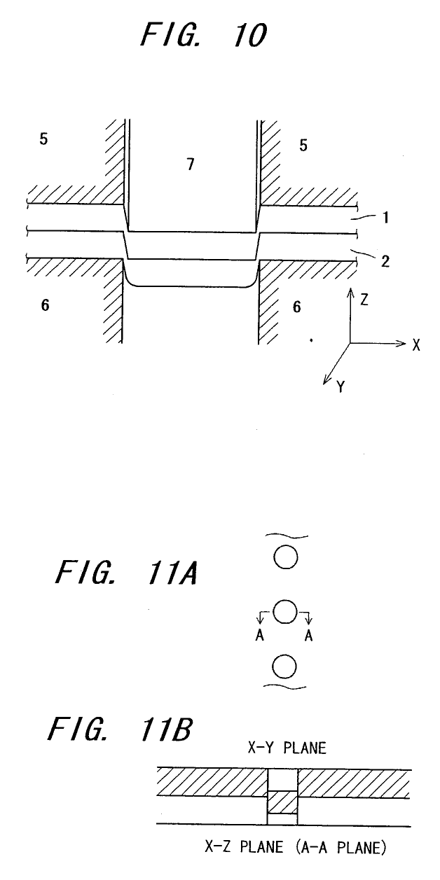

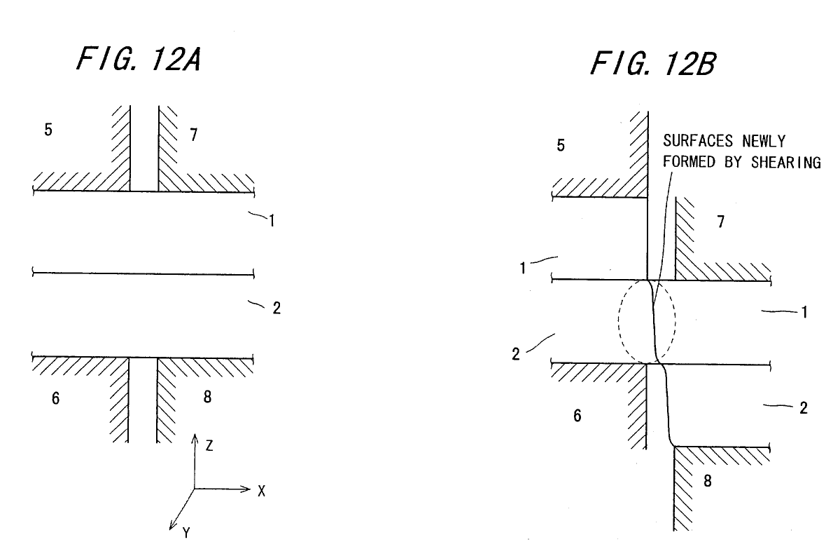

In FIG. 10, the preceding material overlies the following material. However, the positional relationship between the preceding and following materials is not limited thereto; i.e., the following material may overlie the preceding material.

FIGS. 10, 11A, and 11B show the conditions of the preceding and following materials in the process of and after joining as viewed on a cross section taken along the thickness of a steel plate (as viewed on the X-Z plane). Notably, in order to explain the condition of a joint along the width direction of a steel plate, FIG. 11A shows a view of the X-Y plane as viewed from above the steel plate.

In FIGS. 9A and 9B, the clamp, punch, and punch-backing member are vertically movable, and the die is stationary. However, the die is not necessarily stationary, but may be vertically movable under certain conditions.

As shown in FIGS. 9A and 9B, the steel plate splicing facility according to the present embodiment assumes a basic configuration similar to that of the first embodiment and differs from the first embodiment in that, as shown in FIGS. 11A and 11B, an arbitrary number of joint surfaces are present along the width direction of the steel plates (along the Y direction); i.e., the joint surface is not continuously present along the width direction of the steel plates.

Thus, according to the present embodiment, a shear-joining apparatus 200 is configured such that a vertically movable punch 7 is sandwiched between two clamps 5 which are vertically movable in relation to corresponding stationary dies 6. As shown in FIG. 10, the punch 7 is pressed down so as to shear the preceding material 1 and the following material 2, whereby the respective newly-formed surfaces are joined together.

As in the case of the first embodiment, the present embodiment is also characterized in that, at a steel plate temperature equal to or higher than 350° C., a joint is formed under good conditions such that the strength of the joint is higher than that of base material and that, when the percentage clearance c/t defined above by Eq. (1) is equal to or lower than 5%, a joint is formed under good conditions such that the strength of the joint is higher than that of base material.

In the present embodiment, a joint has a cylindrical joint surface. However, the present invention is not limited thereto. The joint surface may have any shape such as a rectangular shape.

What is claimed is:

1. A steel plate splicing facility comprising:
a steel plate heating apparatus for heating a preceding material and a following material to a predetermined temperature, the preceding material being a steel plate currently undergoing pickling, or pickling and cold rolling, and the following material being a next steel plate to undergo pickling, or pickling and cold rolling; and
a shear-joining apparatus for clamping a tail end portion of the preceding material and a leading end portion of the following material in an overlapping condition by means of a die and a clamp and for shearing the tail end portion of the preceding material and the leading end portion of the following material by means of a punch in such a manner that surfaces of the tail end portion and the leading end portion that are newly formed as a result of the shearing are brought in contact with each other in order to join the leading end portion of the following material to the tail end portion of the preceding material.

2. A steel plate splicing facility according to claim 1, wherein the steel plate heating apparatus comprises a device for heating the following material through induction heating, and a device for nipping the preceding material and the following material by means of a heating clamp in order to heat the preceding material and the following material through contact heat conduction from the heating clamp, the heating clamp being preheated through induction heating.

3. A steel plate splicing facility according to claim 1, wherein the steel plate heating apparatus comprises a device for heating the following material through induction heating, and a device for heating the preceding material and the following material in an overlapping condition through induction heating.

4. A steel plate splicing facility according to claim 1, wherein the steel plate heating apparatus comprises a device for heating the preceding material and the following material in an overlapping condition through induction heating.

5. A steel plate splicing facility according to claim 1, wherein the shear-joining apparatus performs joining of the steel plates at a steel plate temperature equal to or higher than 350° C. and at a percentage clearance c/t equal to or lower than 5%, the percentage clearance c/t being defined by
c/t=D/(t₁+t₂)×100
where D represents a distance between the punch and the die, and t₁ and t₂ represent respective thicknesses of the preceding material and the following material as measured at a location where the preceding material and the following material overlap each other.

6. A steel plate splicing facility according to claim 1 or 5, wherein the shear-joining apparatus performs joining such that a joint surface extends linearly.

7. A steel plate splicing facility according to claim 1 or 5, wherein the shear-joining apparatus performs joining such that a joint surface extends nonlinearly.

8. A steel plate splicing facility according to claim 1, wherein the shear-joining apparatus performs joining such that the steel plate on a side toward the punch is pressed by means of the punch so as to be joined to the other steel plate at an arbitrary number of positions along a width direction of the steel plate.

9. A steel plate splicing facility according to claim 1 or 8, wherein the shear-joining apparatus performs joining such that the punch forms a cylindrical joint surface.
